(19) United States
(12) Patent Application Publication
(10) Pub. No.: US 2012/0229011 A1
(43) Pub. Date: Sep. 13, 2012

(54) HIGH PRESSURE DISCHARGE LAMP ELECTRODE, METHOD FOR MANUFACTURING THE SAME, AND HIGH PRESSURE DISCHARGE LAMP

(75) Inventor: Kazushi Tominaga, Gyoda-shi (JP)

(73) Assignee: IWASAKI ELECTRIC CO., LTD., Chuo-ku, Tokyo (JP)

(21) Appl. No.: 13/509,067

(22) PCT Filed: Nov. 10, 2010
(86) PCT No.: PCT/JP2010/070033

§ 371 Date: May 10, 2012

(30) Foreign Application Priority Data
Dec. 16, 2009 (JP) 2009-285203

(51) Int. Cl. H01J 61/52; H01J 9/18

(52) U.S. Cl. 313/39; 445/50

(57) ABSTRACT

A high pressure discharge lamp electrode of the present invention includes a core rod (10), a head (20), and a coil (30) covering the head. The head includes a smaller-diameter section (21) on the core-rod side and a larger-diameter section (22) on a tip side. The coil covers the smaller-diameter section such that a winding-start end portion (30a) of the lowermost layer is positioned at the tip side of the smaller-diameter section, and covers the smaller-diameter section and the larger-diameter section such that a winding-finish end portion (30b) of the uppermost layer is positioned on the larger-diameter section. At least a portion of the coil is welded to the larger-diameter section.

### TECHNICAL FIELD

The present invention relates to an electrode structure of a high pressure discharge lamp.

### BACKGROUND ART

FIG. 8 shows a conventional high pressure discharge lamp electrode (hereinafter referred to as the “electrode”). As shown in FIG. 8, the electrode includes a core rod 10, a head 60 and a coil 70, in which the coil 70 covers the head 60 and a tip-end portion 70a and a rear-end portion 70b of the coil 70 are welded to the head 60 (e.g., Patent Document 1). In Patent Document 1, a coil is wound around a core rod in multiple layers, and a front-end portion and a rear-end portion of the coil are melted by a laser. The rear-end portion is thus fixed to the core rod and the front-end portion is thus formed in a dome shape. The coil covering the head generally has a function to adjust the temperature of the electrode. The function determines ignition characteristics and heat radiation characteristics during discharge, and as a result, determines discharge characteristics.

Here, it is preferable that the rear-end portion of the coil is completely melted, leaving no coil end portions and uneven portions (particularly, projections) caused by welding. If the coil end portion or projections caused by welding are left at the rear side of the coil, discharge from the rear end of the coil at the start of ignition of the lamp is likely to start from that uneven portions. This causes a spattering phenomenon or blackening caused by scattered tungsten adhering to the inner wall of the bulb. This is because, when the lamp is ignited, currents concentrate on a non-smooth welded portion end surface and locally heated tungsten is evaporated in a radially scattering manner.

Moreover, Patent Document 2, for example, discloses a technique of melting a coil end portion in a fillet shape as a technique of welding a coil end portion to a head in a smooth shape. By melting the coil end portion to the head in the fillet shape as described above, the melted coil end portion is smoothly formed, and thus projections caused by welding are eliminated.

### CITATION LIST

### Patent Document

Patent Document 1: Japanese Patent Application Laid-Open No. 2004-362861
Patent Document 2: Japanese Patent Application Laid-Open No. 2000-231902

### SUMMARY OF INVENTION

### Technical Problem

However, it is difficult to apply, to the end portion of the densely wound coil, the technique of melting the coil end portion to the head in the fillet shape as described in Patent Document 2. In the above technology, the coil end portion needs to be melted after being separated from the coil wound section adjacent thereto. However, it is difficult to control how much the coil end portion and the coil wound section should be separated from each other. The increased manufacturing variations result in variations in the ignition characteristics. Moreover, gaps between the coils also cause variations in the heat radiation characteristics (i.e., discharge characteristics) of the coil during discharge.

Therefore, it is an object of the present invention to provide an electrode structure in which a coil is fixed to a head such that, even in a densely wound coil, none of projections caused by welding, the winding-start end portion of the coil, and the winding-finish end portion of the coil are disposed at the rear side of the coil.

### Solution to Problem

A first aspect of the present invention is a high pressure discharge lamp electrode including a core rod (10), a head (20), and a coil (30) covering the head, in which at least a portion of the coil is wound in multiple layers, and the coil is wound by one turn or more at a position closer to the core rod than end portions (30a, 30b) of the coil.

Here, a winding-start end portion (30a) of the coil may be covered with an upper layer coil portion.

A second aspect of the present invention is a high pressure discharge lamp electrode including a core rod (10), a head (20), and a coil (30) covering the head, in which the head includes a smaller-diameter section (21) on the core-rod side and a larger-diameter section (22) on a tip side, the coil covers the smaller-diameter section such that a winding-start end portion (30a) of the lowermost layer is positioned at the tip side of the smaller-diameter section, and covers the smaller-diameter section and the larger-diameter section such that a winding-finish end portion (30b) of the uppermost layer is positioned on the larger-diameter section, and at least a portion of the coil is welded to the larger-diameter section.

A third aspect of the present invention is a high pressure discharge lamp electrode including a core rod (10), a head (20), and a coil (30) covering the head, in which the head includes a smaller-diameter section (21) on the core-rod side and a larger-diameter section (22) on a tip side. The coil includes a first coil (31) covering the smaller-diameter section and a second coil (32) covering the larger-diameter section. The first coil is wound in multiple layers such that both end portions (31a, 31b) thereof are positioned at the tip side of the smaller-diameter section. The second coil covers the larger-diameter section so as to come into contact with the first coil. Both end portions of the first coil and at least a portion of the outermost turn, on the core-rod side, of the second coil are welded together. A portion of at least the outermost turn of the second coil on the coil-end portion (32a) side thereof on the tip side of the larger-diameter section is welded to the larger-diameter section.

A fourth aspect of the present invention is a method for manufacturing a high pressure discharge lamp electrode, including the process of: cutting a head (20) to form a smaller-diameter section (21) on a core-rod side and a larger-diameter section (22) on a tip side (S10); previously forming a coil (30) having an inner diameter matching outer diameters of the smaller-diameter section and the larger-diameter section such that a winding-start end portion (30a) of the coil is in a lower layer of the coil, a winding-finish end portion (30b) is in an upper layer of the coil, and the winding-start end portion is covered with the upper layer (S11); fitting the coil onto the head from the core-rod side with the winding-finish end portion set at the front until the winding-start end portion comes into contact with the larger-diameter section (S12); and welding a portion of at least the outermost turn of the second coil on the coil-end portion (32a) side thereof on the tip side of the larger-diameter section (S13).

A fifth aspect of the present invention is a method for manufacturing a high pressure discharge lamp electrode, including the steps of: cutting a head (20) to form a smaller-diameter section (21) on the core-rod side and a larger-diameter section (22) on the tip side (S20); forming a first coil (31) in multiple layers having an inner diameter equal to an outer diameter of the smaller-diameter section such that both end portions (31a, 31b) of the first coil face each other (S21); forming a second coil (32) having an inner diameter equal to an outer diameter of the larger-diameter section (S22); fitting the first coil onto the smaller-diameter section from the core-rod side with the both end portions thereof set at the front until the first coil comes into contact with the larger-diameter section (S23); fitting the second coil onto the larger-diameter section from the tip side until the second coil comes into contact with the first coil (S24); welding the both end portions s of the first coil to at least a portion of the outermost turn, on the core-rod side, of the second coil (S25); and welding to the larger-diameter section a portion of at least the outermost turn of the second coil on the coil-end-portion (32a) side thereof on the tip side of the larger-diameter section (S26).

A sixth aspect of the present invention is a high pressure discharge lamp including a pair of electrodes (40) each formed using the high pressure discharge lamp electrode described above, and an bulb (50), in which the pair of high pressure discharge lamp electrodes are disposed facing each other inside the bulb.

### BRIEF DESCRIPTION OF DRAWINGS

FIG. 1A is a view showing an electrode of the present invention.

FIG. 1B is a view showing an electrode of the present invention.

FIG. 2A is a cross-sectional view showing a method for manufacturing an electrode according to a first embodiment of the present invention.

FIG. 2B is a cross-sectional view showing the method for manufacturing the electrode according to the first embodiment of the present invention.

FIG. 2C is a cross-sectional view showing the method for manufacturing the electrode according to the first embodiment of the present invention.

FIG. 2D is a cross-sectional view showing the electrode according to the first embodiment of the present invention.

FIG. 3 is a flowchart showing the method for manufacturing the electrode according to the first embodiment.

FIG. 4A is a cross-sectional view showing a method for manufacturing an electrode according to a second embodiment of the present invention.

FIG. 4B is a cross-sectional view showing the method for manufacturing the electrode according to the second embodiment of the present invention.

FIG. 4C is a cross-sectional view showing the electrode according to the second embodiment of the present invention.

FIG. 5A is a photograph showing the second embodiment of the present invention.

FIG. 5B is a photograph showing the second embodiment of the present invention.

FIG. 5C is a photograph showing the second embodiment of the present invention.

FIG. 6 is a flowchart showing the method for manufacturing the electrode according to the second embodiment.

FIG. 7 is a view showing a high pressure discharge lamp of the present invention.

FIG. 8 is a view showing a conventional electrode.

### DESCRIPTION OF EMBODIMENTS

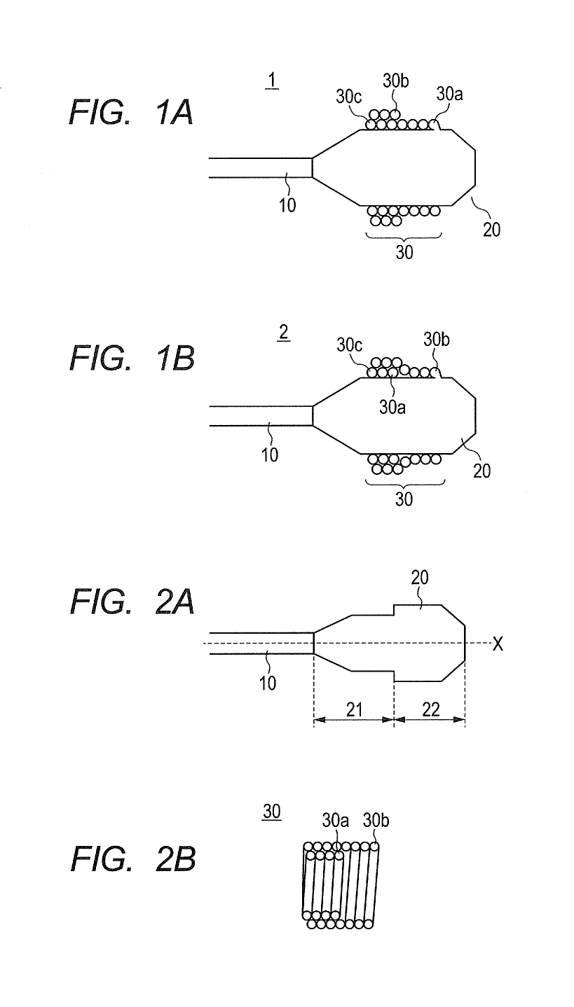

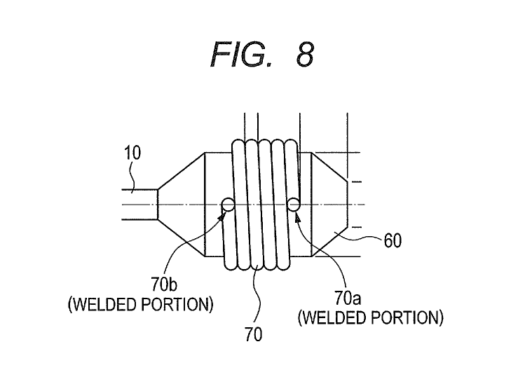

The present invention has a basic arrangement in which the winding-start or winding-finish end portion of a coil and a welded portion of the coil are disposed so as not to be disposed at an end portion on the core-rod side (hereinafter referred to as the “rearward end”). FIG. 1A shows the most basic example. FIG. 1A is a cross-sectional side view of an electrode 1. In FIG. 1A, a coil 30 having a winding-start end portion 30a and a winding-finish end portion 30b covers a head 20. The coil 30 is previously formed into a shape as shown in FIG. 1A, and then fitted onto the head 20. Then, a portion of at least the outermost turn on the winding-start portion (e.g., the winding-start end portion 30a) of the coil 30 is welded to the head 20. In this way, the coil 30 is fixed to the head 20 such that neither of the end portions of the coil 30 is disposed near the rearward end 30c. By disposing the winding-finish end portion 30b away from the rearward end 30c, discharge therefrom is made less likely to occur compared with the conventional example shown in FIG. 8.

Furthermore, FIG. 1B shows an extended example of FIG. 1A. In an electrode 2 shown in FIG. 1B, a coil 30 having a winding-start end portion 30a and a winding-finish end portion 30b covers a head 20. Moreover, at least a portion of at least the outermost turn (e.g., the winding-finish end portion 30b) of the coil 30 is welded to the head 20. The electrode 2 shown in FIG. 1B is different from that shown in FIG. 1A in that the winding-start end portion 30a is completely covered with the upper-layer coil and thus is not exposed. More specifically, the electrode 2 has a configuration that causes no discharge from at least the winding-start end portion 30a.

As described above, the configuration shown in FIG. 1A or FIG. 1B can achieve the object of the present invention (fixing the coil to the head such that none of projections caused by the welding, the winding-start end portion of the coil, and the winding-finish end portion of the coil are disposed at the rearward end of the coil). However, description is given below of most preferred embodiments in consideration of electrode performance and productivity.

### Embodiment 1

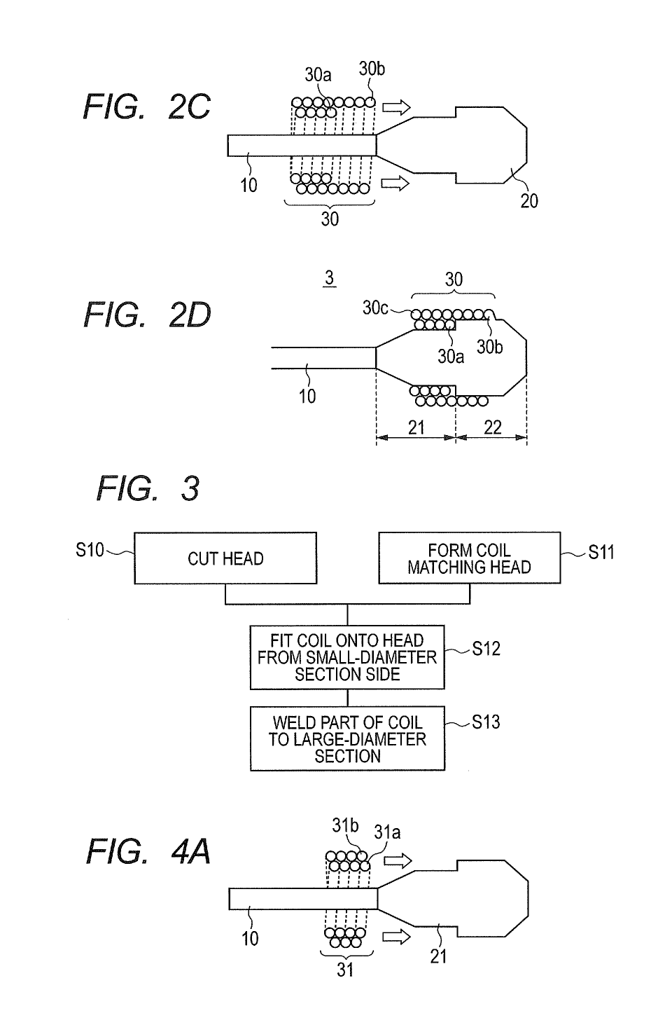

FIG. 2D shows an electrode 3 according to a first embodiment. The electrode 3 includes a core rod 10, a head 20 and a coil 30 covering the head. The head 20 includes a smaller-diameter section 21 on the core-rod side and a larger-diameter section 22 on the tip side. The coil 30 covers the smaller-diameter section 21 such that the winding-start end portion 30a in the lowermost layer (first layer) is positioned on the tip side of the smaller-diameter section 21, and covers the smaller-diameter section 21 and the larger-diameter section 22 such that the winding-finish end portion 30b in the uppermost layer (second layer) is positioned on the larger-diameter section 22. Then, the winding-finish end portion 30b is welded and fixed to the larger-diameter section 22.

The above configuration has the following advantageous effects.

In fixing the coil 30 to the head 20, none of projections caused by the welding, the winding-start end portion 30a of the coil, and the winding-finish end portion 30b of the coil are disposed at the rearward end 30c of the coil 30. Thus, blackening and spattering are suppressed.

Moreover, the coil 30 having a low heat capacity covers, in multiple layers, the core rod 10 side of the head 20. Thus, the electrode becomes likely to be rapidly heated at the ignition. As a result, start of discharge is facilitated.

Furthermore, the difference in level between the smaller-diameter section 21 and the larger-diameter section 22 allows for the positioning of the coil 30, which can suppress manufacturing variations for electrode performance.

With reference to FIGS. 2A to 2D, FIG. 3 shows a flowchart of a method for manufacturing the electrode 3.

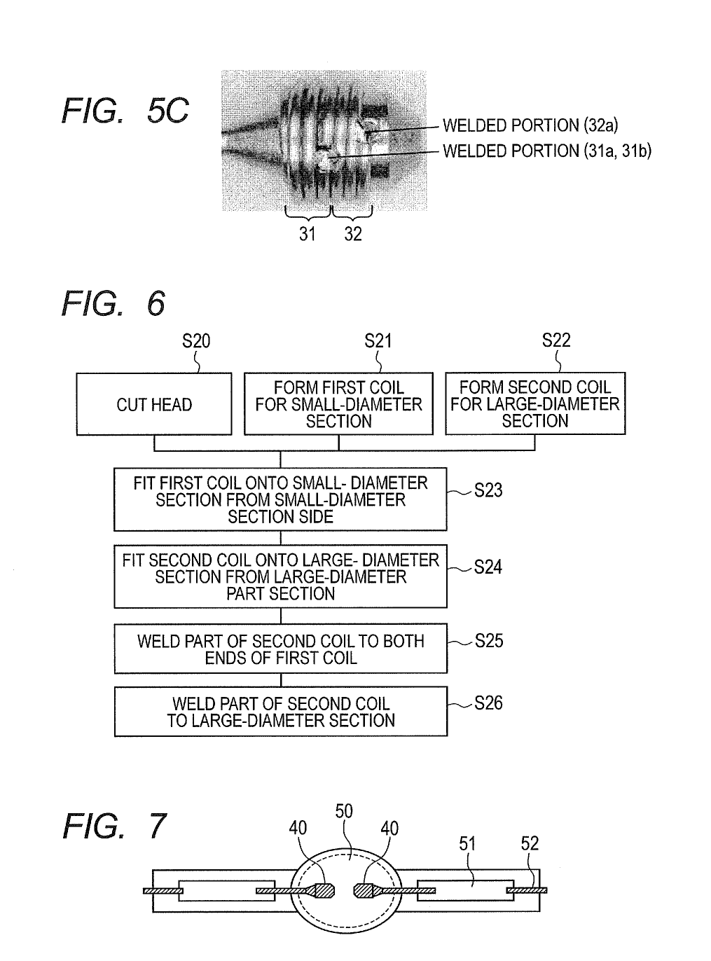

In Step S10, as shown in FIG. 2A, the head 20 is cut to form the smaller-diameter section 21 and the larger-diameter section 22 (see FIG. 5A). The smaller-diameter section 21 preferably has a tapered portion on the core-rod side. It is preferable that the angle of the tapered portion is about 40 degrees to an electrode axis X, which can prevent the head from breaking off from the core rod. Moreover, the larger-diameter section 22 also preferably has a tapered portion on the tip side. It is preferable that the angle of the tapered portion is about 50 degrees to the electrode axis, which can suppress the movement of an arc spot to stabilize the arc. The portions of the head to be actually cut include entire of the smaller-diameter section 21 and the tapered portion of the larger-diameter section 22.

In Step S11, as shown in FIG. 2B, the coil 30 is previously formed, which has an inner diameter matching the shapes (outer diameters) of the smaller-diameter section 21 and the larger-diameter section 22. For the formation of the coil 30, a dedicated jig to be a mold is used. Here, the winding-start end portion 30a of the coil 30 is in a lower layer of the coil 30, the winding-finish end portion 30b is in an upper layer of the coil 30, and the winding-start end portion 30a is covered with the upper layer. Moreover, also in the case of formation of a coil having more layers than that shown in FIG. 2B, the winding-finish end portion 30b needs to be not disposed near the rearward end 30c. Note that any of Step S10 and Step S11 may be performed first.

In Step S12, the coil 30 formed in Step S11 is fitted onto the head 20 from the core-rod side with the winding-finish end portion 30b set at the front as shown in FIG. 2C. Here, the coil is fitted onto the head 20 until the winding-start end portion 30a comes into contact with the larger-diameter section 22.

In Step S13, at least a portion (e.g., the winding-finish end portion 30b) of the coil 30 is welded to the larger-diameter section 22. Thus, the electrode 3 shown in FIG. 2D is manufactured.

### Embodiment 2

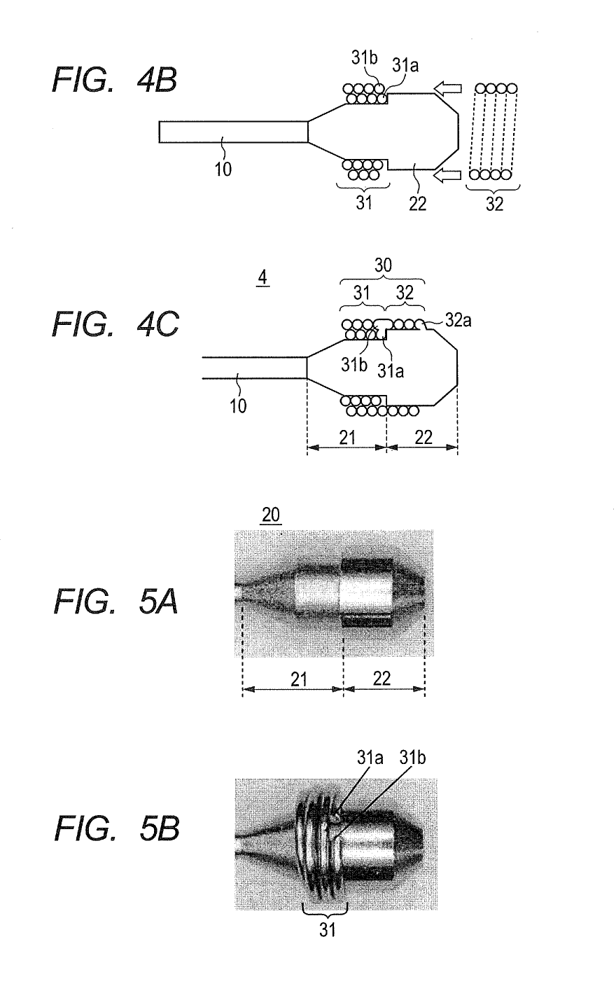

FIG. 4C shows an electrode 4 according to a second embodiment. While the description has been given of the electrode manufactured using the coil 30 in the first embodiment, manufacturing of the coil is not always easy, because, for example, a dedicated jig is required to form the coil having two different inner diameters as shown in FIG. 2B. Thus, Embodiment 2 shows a coil that can be more easily manufactured than that of Embodiment 1.

The electrode 4 includes a core rod 10, a head 20, and a coil 30 covering the head 20. The coil 30 includes a first coil 31 and a second coil 32. As in the case of FIG. 2A, the head 20 includes a smaller-diameter section 21 on the core-rod side and a larger-diameter section 22 on the tip side. The first coil 31 covers the smaller-diameter section 21, and the second coil 32 covers the larger-diameter section 22. Here, the first coil 31 is wound in multiple layers (two layers in this embodiment) such that both end portions 31a and 31b thereof are positioned at the tip side of the smaller-diameter section 21. The second coil 32 is disposed so as to come into contact with the first coil 31. The both end portions 31a and 31b of the first coil 31 and a portion of the second coil 32 are welded together. Moreover, an end portion 32a on the tip side of the second coil 32 is welded and fixed to the larger-diameter section 22.

This embodiment has not only the same effect as the first embodiment but also an advantageous effect of high production efficiency since this embodiment does not require a dedicated jig (although a general jig is required) to manufacture the first and second coils 31 and 32.

With reference to FIGS. 4A to 4C and FIGS. 5A to 5C, FIG. 6 shows a flowchart of a method for manufacturing the electrode 4. Note that FIGS. 4A to 4C are cross-sectional side views of the electrode, and FIGS. 5A to 5C are photographs of the top view of the electrode.

In Step S20, the head 20 is cut to form the smaller-diameter section 21 and the larger-diameter section 22 (as in the case of Step S10 in FIG. 3). FIG. 5 show photographs of the head 20 completed.

In Step S21, the first coil 31 is formed, which has multiple layers (two layers in this embodiment) in which the both end portions 31a and 31b face each other. The first coil 31 is wound such that the inner diameter of the first coil 31 matches the outer diameter of the smaller-diameter section 21.

In Step S22, the second coil 32 is formed in a normal manner. The second coil 32 is wound such that the inner diameter of the second coil 32 matches the outer diameter of the larger-diameter section 22.

Note that the order of Steps S20, S21 and S22 is arbitrary.

In Step S23, as shown in FIG. 4A, the first coil 31 is fitted onto the smaller-diameter section 21 from the core-rod side. Here, the coil 31 is fitted onto the smaller-diameter section 21 with the both end portions 31a and 31b set at the front until the first coil 31 comes into contact with the larger-diameter section 22. FIG. 5B shows a photograph when Step S23 is completed. As can be seen from the photograph shown in FIG. 5B, the both end portions 31a and 31b do not always have to be in such a relationship that the both end portions 31a and 31b are respectively in the lower layer and the upper layer of the coil 31 as shown in FIG. 4A.

In Step S24, as shown in FIG. 4B, the second coil 32 is fitted onto the larger-diameter section 22 from the tip side. Here, the second coil 32 is fitted onto the larger-diameter section 22 until the second coil 32 comes into contact with the first coil 31.

In Step S25, the both end portions 31a and 31b of the first coil 31 and a portion of the second coil 32 are welded and fixed together.

In Step S26, at least a portion (e.g., the tip-side end portion 32a) of the second coil 32 is welded to the larger-diameter section 22.

Note that the order of Steps S25 and S26 is arbitrary.

FIG. 4C shows a cross-sectional side view and FIG. 5C shows a photograph of the top view when Steps S25 and S26 are completed.

FIG. 7 shows a high pressure discharge lamp using a pair of electrodes 40 manufactured according to the embodiments described above. The high pressure discharge lamp includes a bulb 50 made of quartz glass or the like and the pair of electrodes 40 disposed facing each other inside the bulb 50. The pair of electrodes 40 may be any of the electrodes 1 to 4 described above. The bulb 50 includes a molybdenum foil 51 connected to each of the electrodes 40, and a lead 52. Note that the bulb 50 is filled with at least mercury and inert gas.

Thus, the present invention can provide the high pressure discharge lamp which is less likely to suffer from blackening or the like, and has good ignitability, reliability and the like.

Although the preferred embodiments of the present invention have been described above, the following should be noted.
(1) The drawings (except for the photographs) are not true to dimensions, and some constituent components are exaggerated or omitted for convenience of explanation.
(2) Although the winding-start end portion and winding-finish end portion of each coil are shown on the same cross-section (i.e., on the same angle to the axis X) for convenience of explanation, the respective end portions may be on different angles to the axis X.
(3) The core rod 10 may be joined to the head 20 that is separate from the core rod 10 or may be cut off from the head 20 with which the core rod 10 is integrated.
(4) Although a laser beam or an electron beam is used for welding, other welding methods may be adopted.

### REFERENCE NUMERALS

1-4 electrode
10 core rod
20 head
21 smaller-diameter section
22 larger-diameter section
30 coil
31 first coil
32 second coil
40 pair of electrodes
50 bulb

1. A high pressure discharge lamp electrode comprising a core rod, a head, and a coil covering the head, wherein
the head comprises a smaller-diameter section on the core-rod side and a larger-diameter section on a tip side,
the coil covers the smaller-diameter section such that a winding-start end portion of the lowermost layer of the coil is positioned at the tip side of the smaller-diameter section, and covers the smaller-diameter section and the larger-diameter section such that a winding-finish end portion of the uppermost layer of the coil is positioned on the larger-diameter section, and
at least a portion of the coil is welded to the larger-diameter section.

2. A high pressure discharge lamp comprising:
a pair of electrodes each comprising the high pressure discharge lamp electrode according to claim 1; and
a bulb, wherein
the pair of high pressure discharge lamp electrodes are disposed facing each other inside the bulb.

3. A high pressure discharge lamp electrode comprising a core rod, a head, and a coil covering the head, wherein
the head comprises a smaller-diameter section on the core-rod side and a larger-diameter section on a tip side,
the coil comprises a first coil covering the smaller-diameter section and a second coil covering the larger-diameter section,
the first coil is wound in multiple layers such that both end portions of the coil are positioned at the tip side of the smaller-diameter section,
the second coil covers the larger-diameter section so as to come into contact with the first coil,
both end portions of the first coil and at least a portion of the outermost turn, on the core-rod side, of the second coil are welded together, and
a portion of at least the outermost turn of the second coil on the coil-end-portion side thereof on the tip side of the larger-diameter section.

4. A high pressure discharge lamp comprising:
a pair of electrodes each comprising the high pressure discharge lamp electrode according to claim 3; and a bulb, wherein the pair of high pressure discharge lamp electrodes are disposed facing each other inside the bulb.

5. A method for manufacturing a high pressure discharge lamp electrode, comprising the process of:
cutting a head to form a smaller-diameter section on a core-rod side and a larger-diameter section on a tip side;
previously forming a coil having an inner diameter matching outer diameters of the smaller-diameter section and the larger-diameter section such that a winding-start end portion of the coil is in a lower layer of the coil, a winding-finish end portion is in an upper layer of the coil, and the winding-start end portion is covered with the upper layer;
fitting the coil onto the head from the core-rod side with the winding-finish end portion set at the front until the winding-start end portion comes into contact with the larger-diameter section; and
welding at least a portion of the coil to the larger-diameter section.

6. A method for manufacturing a high pressure discharge lamp electrode, comprising the process of:
cutting a head to form a smaller-diameter section on the core-rod side and a larger-diameter section on the tip side;
forming a first coil in multiple layers having an inner diameter equal to an outer diameter of the smaller-diameter section such that both end portions of the first coil face each other;
forming a second coil having an inner diameter equal to an outer diameter of the larger-diameter section;
fitting the first coil onto the smaller-diameter section from the core-rod side with the both end portions of the first coil set at the front until the first coil comes into contact with the larger-diameter section;
fitting the second coil onto the larger-diameter section from the tip side until the second coil comes into contact with the first coil;
welding the both end portions of the first coil to at least a portion of the outermost turn, on the core-rod side, of the second coil; and
welding to the larger-diameter section a portion of at least the outermost turn of the second coil on the coil-end-portion side thereof on the tip side of the larger-diameter section.

7. A high pressure discharge lamp electrode comprising a core rod, a head, and a coil covering the head, wherein
at least a portion of the coil is wound in multiple layers, and
the coil is wound by one turn or more at a position closer to the core rod than an end portion of the coil.

8. The high pressure discharge lamp electrode according to claim 7, wherein a winding-start end portion of the coil is covered with an upper layer coil portion.

9. A high pressure discharge lamp comprising:
a pair of electrodes each formed using the high pressure discharge lamp electrode according to claim 7; and a bulb, wherein the pair of high pressure discharge lamp electrodes are disposed facing each other inside the bulb.
